(19) United States
(12) Patent Application Publication
(10) Pub. No.: US 2015/0239475 A1
(43) Pub. Date: Aug. 27, 2015

(54) HYBRID VEHICLE AND METHOD OF OPERATION

(71) Applicant: FORD GLOBAL TECHNOLOGIES, LLC, Dearborn, MI (US)

(72) Inventors: Kerem BAYAR, Ann Arbor, MI (US); Hai YU, Canton, MI (US); Ryan Abraham MCGEE, Ann Arbor, MI (US)

(73) Assignee: FORD GLOBAL TECHNOLOGIES, LLC, Dearborn, MI (US)

(21) Appl. No.: 14/185,981

(22) Filed: Feb. 21, 2014

(51) Int. Cl. B60W 30/18; B60W 10/184; B60W 20/00; B60W 10/08

(52) U.S. Cl. CPC B60W 30/18172; B60W 10/08; B60W 10/184; B60W 20/00; Y10S 903/93

(57) ABSTRACT

A hybrid electric vehicle includes a powertrain controller and an anti-lock braking system (ABS) controller. The powertrain controller modulates the torque delivered by an internal combustion engine, a generator, and a motor to deliver a desired torque to two drive wheels. The ABS controller modulates the braking torque exerted by brakes on each of the four wheels. During modest braking events with good traction, the motor recaptures vehicle kinetic energy. During heavy braking and/or poor traction, the ABS controller and motor controller each respond to speed sensor signals to modulate the motor and brake torques to minimize stopping distance. The motor torque responds more quickly than the brake torque such that the frequency of oscillation is higher for the combined system than for an independent ABS system.

### TECHNICAL FIELD

This disclosure pertains to a method of operating a hybrid electric vehicle to reduce the stopping distance on limited traction surfaces.

### BACKGROUND

The distance required to stop a vehicle is improved if the braking torque at each wheel is maintained near the level corresponding to he maximum friction force available between the tire and the road surface. If he braking torque exceeds this level, he wheel locks-up and slides along the surface. Since the coefficient of friction decreases when he wheel is sliding as opposed to rolling, braking distance increases when wheels are allowed to lock-up. To improve braking performance, many vehicles are equipped with anti-lock braking systems (ABS). When an ABS senses wheel lock-up, it intervenes to apply a lower braking torque than commanded by the driver.

In order to reduce fuel consumption, some vehicles, called hybrid electric vehicles, are equipped with electric motors in addition to the gasoline or diesel powertrain. One of the ways that the electric motor reduces fuel consumption is through regenerative braking When the driver steps on the brake pedal, the powertrain uses the electric motor to apply a braking force instead of the friction brakes generating electricity that is stored in a battery. The stored power is then used later to propel the vehicle reducing the power that must be generated by burning fuel. However, if the electric motor exerts enough braking force to lock-up the wheels, then the ABS will not be able to restore fraction by reducing the torque of the friction brakes.

### SUMMARY OF THE DISCLOSURE

A hybrid electric vehicle has four wheels each of which is equipped with a hydraulically actuated friction brake and a speed sensor. An anti-lock brake system controller monitors the speed sensors and reduces the brake torque in response to an indication of tire slip and then increases the brake torque in response to an indication of regained traction. An electric motor drives two of the vehicle wheels through a differential. A powertrain controller monitors the speed sensors associated with the driven wheels and reduces the motor torque (in absolute value) in response to an indication of tire slip and then increases the motor torque in response to an indication of regained traction. The electric motor responds more quickly than the hydraulic brake actuators. The cycle of increasing and decreasing torque results in oscillating torques with given frequencies. The faster response of the electric motor results in a higher frequency than hydraulic brakes acting alone, such as occurs on the non-driven wheels.

Wheel slip may be indicated by a negative rate of change of wheel speed below a threshold value. Alternatively, wheel slip may be indicated by a wheel speed that differs by more than a threshold value from an expected wheel speed based on vehicle speed and tire radius. Vehicle speed may be estimated, for example, by averaging the speeds of non-slipping wheels. Similarly, regained traction may be indicated by positive rate of change of wheel speed above a threshold value. Alternatively, regained traction may be indicated by a wheel speed that is within a threshold value of an expected wheel speed based on vehicle speed and tire radius.

### BRIEF DESCRIPTION OF THE DRAWINGS

FIG. 1 is a schematic representation of a hybrid electric vehicle powertrain.

FIG. 2 is a schematic representation of an anti-lock braking system.

FIG. 3 is a schematic representation of a controller.

FIG. 4 is a set of graphs illustrating the operation of an anti-lock braking system during a deceleration without intervention from the hybrid powertrain.

FIG. 5 is a set of graphs illustrating the operation of an anti-lock braking system during a deceleration with participation of the hybrid powertrain.

FIG. 6 is a flow chart illustrating the method of operation with participation of the hybrid powertrain.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

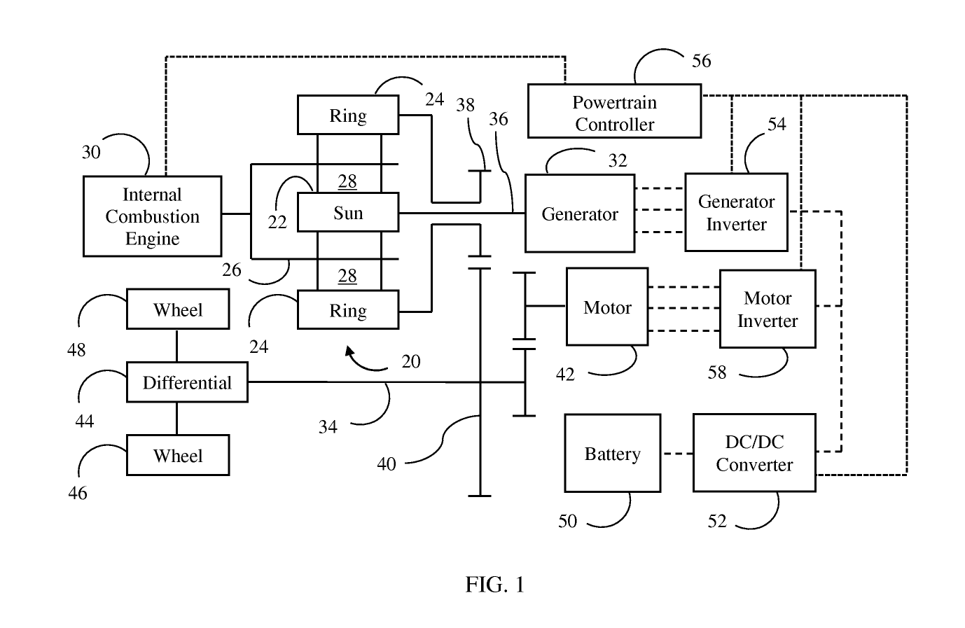

FIG. 1 is a schematic representation of a power-split type hybrid vehicle. Solid lines represent mechanical connections among components. Lines with long dashes represent electrical power connections among components. Lines with short dashes represent signal connections. This configuration is called a power-split because planetary gear set 20 splits the power flowing from the engine to the wheels into a mechanical power flow path and an electrical power flow path. Planetary gear set 20 includes sun gear 22, ring gear 24, and carrier 26 which rotate about a common axis. A number of planet gears 28 are supported for rotation with respect to carrier 26 and mesh with both sun gear 22 and ring gear 24.

Internal combustion engine 30 is drivably connected to carrier 26. Sun gear 22 is driveably connected to generator 32. Ring gear 24 is drivably connected to output shaft 34. A driveable connection is established between two components if rotation of one component causes the other component to rotate at a proportional speed. In FIG. 1, the driveable connection between sun gear 22 and generator 32 is a solid shaft 36 whereas the driveable connection between ring gear 24 and output shaft 34 includes gears 38 meshing with gear 40. Output shaft 34 is also driveably connected to traction motor 42 and differential 44. Differential 44 transmits power to a left front wheel 46 and a right front wheel 48 while permitting slight variations in speed, such as when the vehicle turns a corner.

Generator 32 and traction motor 42 are both reversible electrical machines capable of converting electrical energy into rotational mechanical energy and converting rotational mechanical energy into electrical energy. As illustrated in FIG. 1, generator 32 is an alternating current (AC) motor electrically connected to battery 50 via DC/DC converter and inverter 54. Inverter 54 converts direct current (DC) to three phase alternating current in response to commands from powertrain controller 56. The voltage level, frequency, and phase angle of the three phase alternating current determine the resulting torque level. Similarly, inverter 58 converts direct current to three phase alternating current for traction motor 42. Alternatively, generator 32 and/or traction motor 36 may be DC motors.

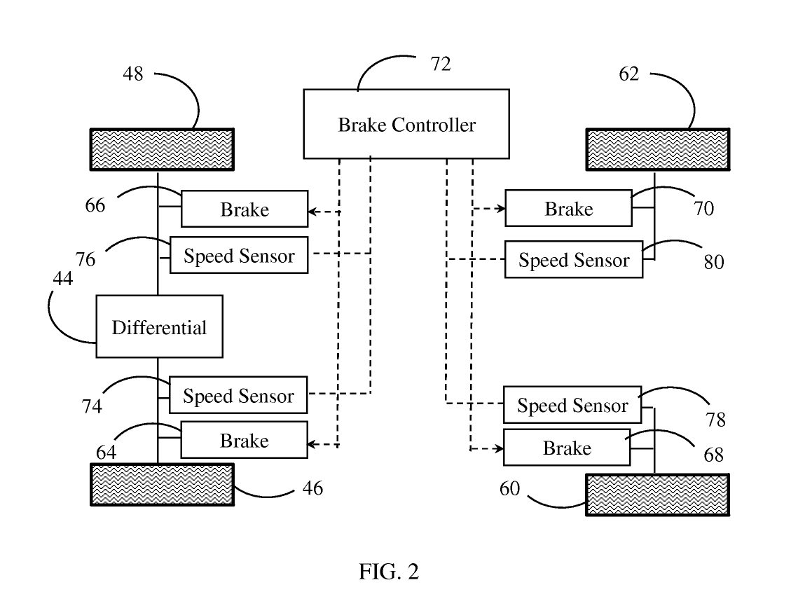

FIG. 2 is a schematic representation of the anti-lock brake (ABS) system. In addition to front wheels 46 and 48, the vehicle has a left rear wheel 60 and a right rear wheel 62. As illustrated, the rear wheels are not powered, but the rear wheels may be powered in some embodiments. Hydraulic brakes 64, 66, 68, and 70 apply torque to wheels 46, 48, 60, and 62 respectively in response to signals from brake controller 72. Speed sensors 74, 76, 78, and 80 measure the speeds of wheels 46, 48, 60, and 62 respectively and communicate these speeds to brake controller 72.

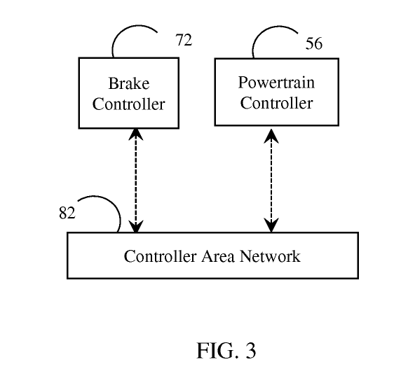

As shown in FIG. 3, brake controller 72 and powertrain controller 56 communicate with one another via a controller area network (CAN) 82. Specifically, brake controller 72 makes signals from speed sensors 74, 76, 78, and 80 available to powertrain controller 56 via CAN 82. Alternatively, brake controller 72 and powertrain controller 56 could be integrated into a single controller.

When the driver presses a brake pedal, braking can be accomplished either by commanding negative torque from motor 42 or by commanding the brakes to apply torque to each of the wheels. For low levels of braking on surfaces with good traction, regenerative braking via motor 42 is preferable because the energy can be recovered and later used for propulsion. The motor torque is divided approximately equally between the two front wheels 46 and 48 by differential 44. However, the brakes may be capable of generating more braking torque than motor 42 and are capable of applying a different level of torque to each of the four wheels.

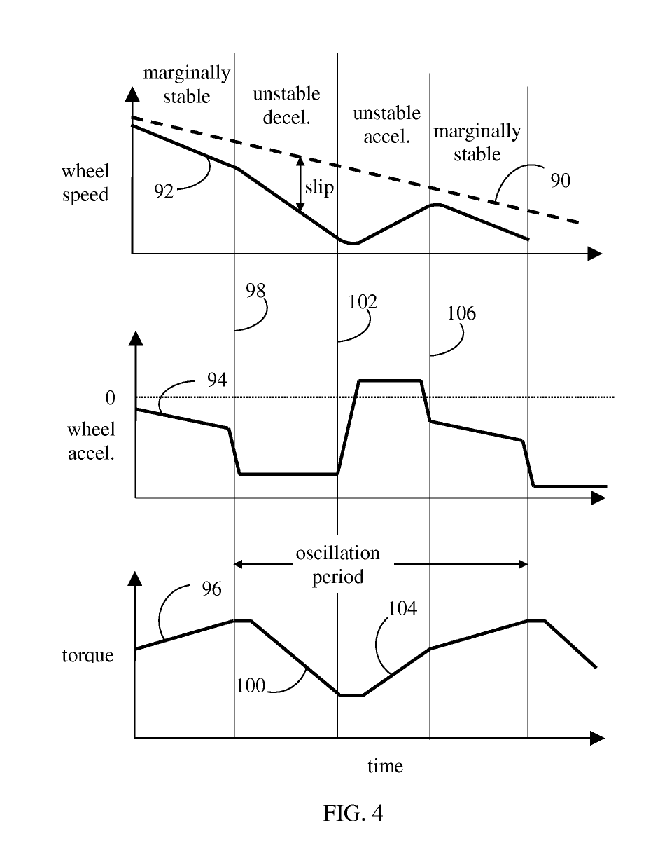

For high levels of braking or when the surface is slippery, brake controller 72 enters an anti-lock brake (ABS) control mode as illustrated in FIG. 4. The objective in ABS mode is to decrease the vehicle speed as rapidly as possible subject to the available wheel traction. The dotted line in the top graph 90 indicates the vehicle speed divided by the wheel radius. Controller 72 may infer this value by, for example, averaging the values of the wheel speed sensors. The solid line in the top graph 92 indicates the value of one of the speed sensors 74, 76, 78, or 80. The difference between these two lines at any point in time is the wheel slip at that moment. The middle graph in FIG. 4 indicates the wheel acceleration 94. Controller 72 may calculate this value by computing a time derivative of the wheel speed signal. The bottom graph shows the torque applied by the corresponding brake.

Controller 72 adjusts the commanded torque based on formulas that depend on the state of traction for the wheel. In the first phase, called a marginally stable phase, wheel speed generally tracks vehicle speed with low levels of slip indicating that the tire has acceptable traction. During this phase, the controller gradually increases the torque command as shown at 96. In FIG. 4, this is indicated by a ramp function. In practice, the controller may adjust the commanded torque at regular intervals such that the increase is performed in a series of discrete steps. At 98, the tire loses fraction and an unstable decelerating mode begins. The controller may detect this mode transition, for example, by a wheel acceleration value that falls below a calibrateable threshold value. The controller may estimate wheel acceleration based on the difference between the current sensed wheel speed and the sensed wheel speed at a previous time such as the previous control loop. In the unstable decelerating mode, the controller decreases the commanded torque in an attempt to regain traction as quickly as possible, as shown at 100. The rate of decrease may be limited by physical responsiveness limitations of the brake actuator. Once the brake torque declines sufficiently, the tire regains traction as shown at 102. The controller enters an unstable accelerating mode in response to wheel acceleration exceeding a calibrateable threshold value or slip decreasing below a calibrateable threshold. In unstable accelerating mode, the controller gradually increases the commanded brake torque as shown at 104. At 106, the controller returns to the marginally stable mode and the process repeats.

Due to the repeating nature of this process, the brake torque oscillates with a frequency determined by the oscillation period. The braking is most effective during the marginally stable phase and less effective during the unstable decelerating phase when the tire has lost its traction. Braking performance is maximized by decreasing the duration of each unstable decelerating and unstable accelerating mode. However, physical limitations of the hydraulic brake actuators limit their responsiveness and therefore limit the ability of the controller to rapidly reestablish traction.

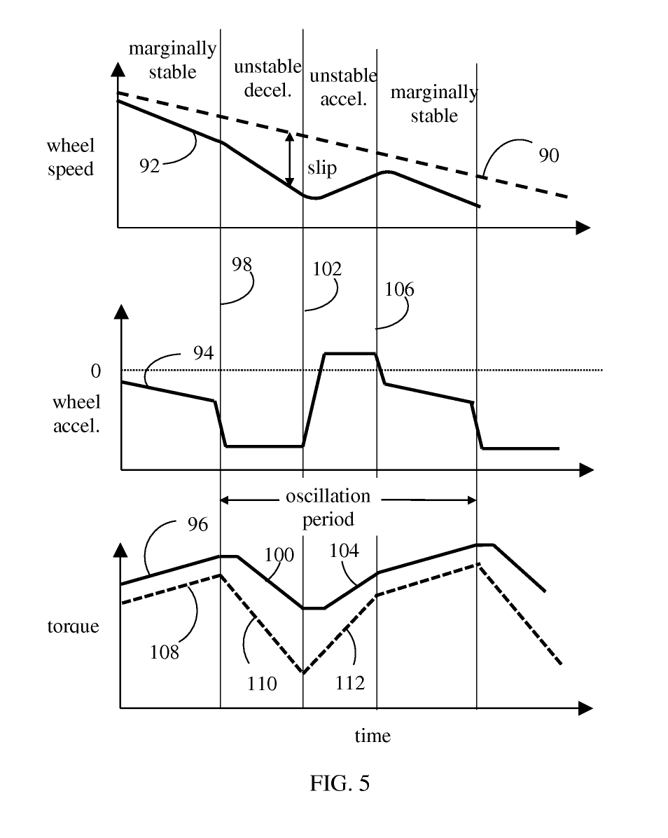

The braking performance can be enhanced by taking advantage of the more responsive nature of electric motor 42 relative to the brake actuators, as illustrated in FIG. 5. In the bottom graph, the torque of one of the front brakes 64 or 66 is shown as a solid line and the absolute value of the motor torque is shown as a dotted line. In marginally stable mode, the motor torque gradually increases as shown at 108. In unstable decelerating mode, the motor torque decreases as shown at 110. Since the motor responds more quickly than a hydraulic brake actuator, the motor torque begins to decrease faster than the brake torque and decreases at a faster rate. As a result, the wheel regains traction sooner than it would have without the motor contribution. In other words, the duration of the unstable decelerating mode is shorter. During unstable accelerating mode, the motor torque increases as shown at 112. The motor torque begins increasing before the brake torque and increases at a faster rate than the brake torque which tends to decrease the duration of the unstable accelerating phase. Since the unstable decelerating phase and the unstable accelerating phase are both shorter, the oscillation period decreases and the frequency increases. In the powertrain configuration of FIG. 1, motor 42 only influences the front wheels. The rear brakes would continue to respond as shown in FIG. 4. Therefore, the frequency of oscillation of the front brakes is higher than the frequency of oscillation of the rear brakes.

The method of FIG. 5 does not require a supervisory level controller to coordinate the actions of the powertrain controller and the ABS controller. The powertrain controller need not communicate directly with the ABS controller. Although FIG. 3 shows the two controllers communicating via a controller area network, the only information exchanged is the wheel speed sensor readings. Alternatively, both controllers could directly read the sensor outputs. Like the ABS controller, the motor controller may adjust the motor torque at regular intervals such that the motor torque changes in a series of discrete steps rather than a continuous ramp. Due to the faster response of the motor, the interval between control loops may be shorter than for the ABS controller. A shorter control loop interval has the added advantage of more accurate estimate of wheel acceleration.

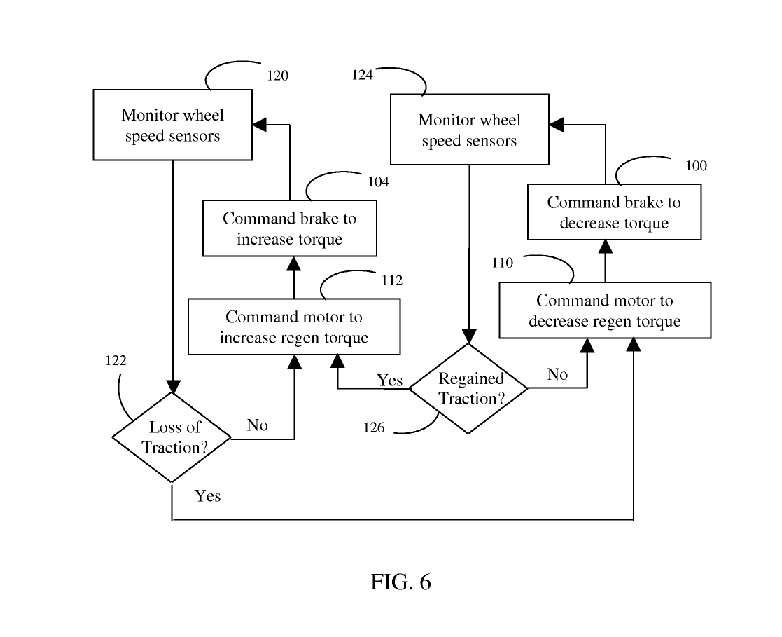

The method of FIG. 5 is summarized in the flow chart of FIG. 6. After braking begins, the method monitors the speeds of the wheels at 120. If, at 122, all tires still have traction, then the motor torque is increased in absolute value at 112 and the brake torque is increased at 104. This process repeats until a loss of traction is detected at 122. Then, the motor torque is decreased in absolute value at 110 and the brake torque is decreased in absolute value at 100, and monitoring continues at 124. This process repeats until traction is regained as detected at 126. Note that steps 120, 122, 124, and 126 may be performed independently by both brake controller 72 and powertrain controller 56. The rate of change of motor torque changes direction before the rate of change of brake torque due to the faster response time of the corresponding actuator.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
left and right wheels, each wheel associated with a speed sensor and a brake actuator;
a differential having an input driven by an electric motor and left and right outputs driving the left and right wheels respectively; and
a controller programmed to respond to an indication of loss of traction by decreasing a motor torque and then decreasing a brake torque of the corresponding brake actuator and to respond to an indication of regained traction by increasing the motor torque and then increasing the brake torque of the corresponding brake actuator.

2. The vehicle of claim 1 wherein the indication of loss of traction comprises a negative rate of change of wheel speed below a threshold value.

3. The vehicle of claim 1 wherein the indication of loss of traction comprises a wheel speed measurement that is at least a threshold value less than a value based on vehicle speed and tire diameter.

4. The vehicle of claim 3 wherein the vehicle speed is based on an average of other wheel speed measurements.

5. The vehicle of claim 1 wherein the indication of regained traction comprises a positive rate of change of wheel speed above a threshold value.

6. The vehicle of claim 1 wherein the indication of regained traction comprises a wheel speed that is within a threshold value of a value based on vehicle speed and tire diameter.

7. The vehicle of claim 6 wherein the vehicle speed is based on an average of other wheel speed measurements.

8. The vehicle of claim 1 further comprising:
a planetary gear set having a sun gear, a carrier, and a ring gear, the ring gear driveably connected to the motor;
an internal combustion engine driveably connected to the carrier; and
an electric generator driveably connected to the sun gear.

9. A method of controlling a vehicle to reduce stopping distance, the vehicle having an electric motor configured to drive left and right wheels through a differential and brakes associated with each wheel, the method comprising:
monitoring a wheel speed sensor;
decreasing both a motor torque and a brake torque in response to an indication of lost traction; and
increasing both the motor torque and the brake torque in response to an indication of regained traction.

10. The method of claim 9 wherein the motor torque decreases before the brake torque decreases in response to the indication of lost traction.

11. The method of claim 9 wherein the motor torque increases before the brake torque increases in response to the indication of regained traction.

12. The method of claim 9 wherein the indication of lost traction comprises a negative rate of change of wheel speed below a threshold value.

13. The method of claim 9 wherein the indication of lost traction comprises a wheel speed measurement that is at least a threshold value less than a value based on a vehicle speed and a tire diameter.

14. The method of claim 9 wherein the indication of regained traction comprises a positive rate of change of wheel speed above a threshold value.

15. The method of claim 9 wherein the indication of regained traction comprises a wheel speed that is within a threshold value of value based on a vehicle speed and a tire diameter.

16. A vehicle comprising:
first, second, third, and fourth wheels, each wheel associated with a speed sensor and a brake actuator;
a differential having an input driven by an electric motor and left and right outputs driving the first and the second wheels;
a brake controller programmed to respond to signals from the speed sensors associated with the third and fourth wheels by commanding the brake actuators associated with the third and fourth wheels to generate brake torques which oscillate at a first frequency; and
a powertrain controller programmed to response to signals from the speed sensors associated with the first and second wheels by commanding the electric motor to produce a torque which oscillates at a second frequency greater than the first frequency.

17. The vehicle of claim 16 wherein the brake controller is further programmed to respond to signals from the speed sensors associated with the first and second wheels by commanding the brakes actuators associated with the first and second wheels to generate brake torques.

18. The vehicle of claim 17 wherein the brake controller provides signals from the wheel speed sensors to the powertrain controller via a controller area network.

19. The vehicle of claim 16 further comprising:
a planetary gear set having a sun gear, a carrier, and a ring gear, the ring gear driveably connected to the motor;
an internal combustion engine driveably connected to the carrier; and
a generator driveably connected to the sun gear.
